(19) United States
(12) Patent Application Publication
(10) Pub. No.: US 2012/0180298 A1
(43) Pub. Date: Jul. 19, 2012

(54) TERMINATION TOOL AND METHODS THEREFOR

(76) Inventors: Guy Joachin Castonguay, Shanghai (CN); Bin Dai, Shanghai (CN); JiWei Sun, Shanghai (CN)

(21) Appl. No.: 13/405,677

(22) Filed: Feb. 27, 2012

Related U.S. Application Data
(63) Continuation of application No. PCT/US10/44396, filed on Aug. 4, 2010.
(60) Provisional application No. 61/249,027, filed on Oct. 6, 2009.
(60) Provisional application No. 61/238,443, filed on Aug. 31, 2009.

(51) Int. Cl. B25B 27/14; B23P 11/00

(52) U.S. Cl. 29/434; 29/237; 29/720; 29/428

(57) ABSTRACT

A termination tool assembly for terminating a fiber optic cable to a fiber optic connector includes a cam and a base for receiving the cam. The cam serves to rotationally activate a mechanical splice on a mechanical splice connector and thereby terminate the fiber optic cable. The fiber optic connector and fiber optic cable are axially received by the termination tool and are laterally removed from the termination tool after termination as a terminated fiber optic cable assembly.

### CROSS-REFERENCE TO RELATED APPLICATIONS

This application is a continuation of International Application No. PCT/US10/44396 filed Aug. 4, 2010, which claims the benefit of priority to U.S. Provisional Application Ser. No. 61/249,027 filed on Oct. 6, 2009 and U.S. Provisional Application Ser. No. 61/238,443 filed on Aug. 31, 2009, all of which are incorporated herein by reference.

### BACKGROUND

1. Technical Field

A termination tool is disclosed for terminating a fiber optic cable to a fiber optic connector and methods therefor. In particular, the disclosure is a termination tool that terminates a fiber optic cable to a fiber optic connector that employs a mechanical splice and methods therefor.

2. Technical Background

To accommodate bandwidth demand, network operators are investing in and installing optical networks to route optical fibers toward the end user's location, referred to as Fiber to the “X” (FTTX). Conventional connectors used for terminating fiber optic cables require processing usually done in a factory setting. However, in certain applications it is preferable to terminate the ends of fiber optic cable in the field to avoid issues with excess cable length and slack cable storage.

To solve in-the-field cable termination issues, mechanical splice connectors such as the UniCam® available from Corning Cable Systems of Hickory, N.C. were developed. The UniCam® connector allows the craft to easily, quickly and reliably make a mechanical splice connection between a field-fiber and an optical fiber stub in the connector without the need to polish a ferrule endface of the connector in the field. Initially, mechanical splice connectors were intended for termination with indoor fiber cables that included, for example, aramid fibers as strength members. Specifically, the aramid fibers were secured to a portion of the connector using a deformable crimp tube. However, with the push of optical fiber toward user premises, termination in the field to more robust fiber optic cables suitable for outdoor and indoor use is needed. Manufacturers have attempted to develop mechanical splice connectors, tools and methods to field terminate robust fiber optic cables, but the designs are expensive.

### SUMMARY

The disclosure includes tools and methods for terminating fiber optic cables to fiber optic connectors. More specifically, the disclosure includes termination tools and methods that are simple and inexpensive, enabling termination of many types of robust fiber optic cables to fiber optic connectors. The tools disclosed herein receive a connector in one end and a cable in an opposite end, terminate the cable to the connector and allow easy removal of the fiber optic connector and the fiber optic cable. The disclosure provides at least one method of terminating the fiber optic connector to the fiber optic cable using the disclosed termination tools.

One aspect of the disclosure includes a termination tool having a base and a cam. The cam is received by the base and is adapted to rotate within the base for terminating the cable to a mechanical splice connector.

Another aspect of the disclosure includes a termination tool having a clamping structure. The clamping structure may include a locking mechanism for locking the cable to the mechanical splice connector during a termination.

Another aspect of the disclosure includes a termination tool having a portion thereof with a generally arcuate, e.g., C-shaped profile.

Another aspect of the disclosure includes a termination tool having at least one securing member which can be in the form of a catch for securing the mechanical splice connector axially during termination, and providing for lateral removal of the mechanical splice connector after termination.

Another aspect of the disclosure includes a termination tool having at least one positional indicator that indicates an unterminated position and a terminated position. Additionally, the positional indicator may indicate the installation status of the termination tool.

In example embodiments, the termination tools disclosed terminate a fiber optic cable to fiber optic connectors disclosed herein. The fiber optic connector has at least one holder for attaching a fiber optic cable to a fiber optic connector. A first end of the holder attaches to a portion of the connector and a second end of the holder attaches to the cable. The termination tools and methods disclosed herein allow quick and easy attachment of a robust fiber optic cable to a connector.

Additional features will be set forth in the detailed description which follows, and in part will be readily apparent to those skilled in the art from that description or recognized by practicing the described embodiments and the claims, as well as the appended drawings.

It is to be understood that both the general description and the detailed description are exemplary, and are intended to provide an overview or framework to understand the claims. The accompanying drawings are included to provide a further understanding, and are incorporated in and constitute a part of this specification. The drawings illustrate one or more embodiment(s), and together with the description serve to explain principles and operation of the embodiments.

### BRIEF DESCRIPTION OF THE FIGURES

The disclosed features and aspects are better understood when the detailed description is read with reference to the accompanying drawings, in which:

FIG. 1 shows a cross sectional view of an explanatory fiber optic cable;

FIG. 2 shows a perspective view of a fiber optic cable assembly using the fiber optic cable of FIG. 1;

FIG. 3 shows a perspective view of an embodiment of a termination tool;

FIG. 4 shows a perspective view of the base for the tool of FIG. 3;

FIGS. 5 and 6 show two perspective views of the cam for the tool of FIG. 3;

FIG. 7 shows an end view of the cam of FIGS. 5 and 6;

FIG. 8 shows an end view of the base of FIG. 4;

FIG. 9 shows an end view of the tool of FIG. 3 in a first position;

FIG. 10 shows an end view of the tool of FIG. 3 in a second position;

FIGS. 11 and 12 show perspective views of the tool of FIG. 3 in different states of assembly using the cam and base of FIGS. 4-6;

FIG. 13 shows a perspective view of the tool of FIG. 12 prepared to receive a connector sub-assembly;

FIG. 14 shows a top view of the tool of FIG. 13 with a fiber optic cable disposed at the rear of the connector sub-assembly;

FIG.15 shows a top view of the tool of FIG. 14 with a sleeve disposed about the cable and rear of the connector sub-assembly;

FIG. 16 shows a top view of the tool of FIG. 15 with cam rotated from a first position to a second position;

FIG. 17 shows a perspective view of another embodiment of a termination tool having a clamping structure with a locking mechanism;

FIG. 18 shows a top perspective view of the tool of FIG. 17 with a fiber optic cable disposed at the rear of the connector sub-assembly wherein the clamping structure is in a locked position;

FIG. 19 shows a bottom perspective view of the tool of FIG. 18;

FIG. 20 shows a top perspective view of the tool of FIG. 18 in a terminated position with clamping structure open and a sleeve disposed about the cable and rear of the connector sub-assembly;

FIG. 21 shows a top perspective view of yet another embodiment of a termination tool having alternate clamping structure and latch locking mechanism;

FIG. 22 shows a top perspective view of the tool of FIG. 21 prepared to receive a connector sub-assembly;

FIGS. 23-25 show a top perspective view of the tool of FIG. 22 having a connector sub-assembly disposed therein and receiving and securing a fiber optic cable at the rear of the connector sub-assembly, wherein all embodiments are in an unterminated position;

FIG. 26 shows a top perspective view of the tool of FIG. 25 in a terminated position;

FIG. 27 shows a top perspective view of the tool of FIG. 26 in a terminated position wherein the latch locking mechanism is unsecured and prepared to receive a connector sleeve, as shown in FIG. 28;

FIG. 28 shows a top perspective view of the tool of FIG. 27 in a terminated position having the connector sleeve disposed about the end of the connector assembly and the fiber optic cable;

FIG. 29 shows a top perspective view of the tool of FIG. 28 laterally releasing the terminated connector assembly;

FIG. 30 shows another embodiment of a termination tool having side arms and an alternate latch locking mechanism;

FIGS. 31 and 32 show two top views of another embodiment of a base for a termination tool having a sliding clamping structure with side arms and a flexible bridge locking mechanism;

FIGS. 33 and 34 show a perspective view of the base of FIG. 32 receiving a cam;

FIG. 35 shows a perspective view of the tool of FIG. 34 receiving a connector assembly;

FIG. 36 shows the tool of FIG. 35 in an unterminated position and sliding clamping structure in a rearward position;

FIG. 37 shows the tool of FIG. 36 in an unterminated position and sliding clamping structure in a forward position and a fiber optic cable disposed at the rear of the connector assembly;

FIG. 38 shows the tool of FIG. 37 in an unterminated position and sliding clamping structure in an rearward position securing the fiber optic cable to the rear of the connector assembly;

FIG. 39 shows the tool of FIG. 38 in a terminated position and sliding clamping structure displaced by a sleeve disposed about the rear of the connector and the fiber optic cable;

FIGS. 40 and 41 show another embodiment of a termination tool having a cable guide;

FIG. 42 is a partially exploded view of the fiber optic connector of FIG. 2;

FIG. 43 shows an exploded view of the mechanical splice assembly of FIG. 43;

FIG. 44 is a partial cross-sectional view of a portion of the mechanical splice assembly showing the splice parts;

FIG. 45 is a perspective view of a sub-assembly of the fiber optic connector of FIG. 2 before the fiber optic cable is inserted into the fiber optic connector;

FIG. 46 is a view showing a stripping gauge formed on the sleeve of the fiber optic connector for determining the length for stripping the coating of the optical fiber;

FIG. 47 is an assembly view showing the prepared fiber optic cable inserted into a portion of the fiber optic connector of FIG. 46 before the sleeve is slid into place;

FIG. 48 is an assembly view showing the sleeve of the fiber optic connector of FIG. 2 being slid onto a portion of the holder;

FIG. 49 is an assembly view showing the sleeve of the fiber optic connector bending the optical fiber as it is being slid onto the holder;

FIGS. 50 and 51 depict cross-sectional views of a portion of the fiber optic cable assembly during assembly;

FIG. 52 shows a cross-sectional view of the cable assembly of FIG. 2; and

FIGS. 53-56 show further explanatory fiber optic cables suitable for use with the cable assemblies and termination tools disclosed herein.

### DESCRIPTION

A description will now be made in detail to the disclosed embodiments, examples of which are illustrated in the accompanying drawings. Whenever possible, the same reference numerals will be used throughout the drawings to refer to the same or like parts.

The disclosure describes termination tools (10, 40, 50, 60, 70, 80) for terminating a mechanical splice connector to a fiber optic cable. For example, FIG. 1 depicts a cross-sectional view of a fiber optic cable 700 used for FTTX applications. Cable 700 includes optical fiber 702, strength members 704 disposed on opposite sides of optical fiber 702, and a cable jacket 708. As shown, cable jacket 708 of cable 700 includes notches at the top and bottom for providing the craft with access to fiber 702 by tearing apart the cable jacket 708. Cable 700 has a generally rectangular cross-section and may be used for indoor and/or outdoor environments. Due to the rigidity of strength members 704 (e.g., glass reinforced rods or metallic wire) and the stiffness of cable jacket 708, conventional fiber optic connectors are not suitable for field terminating cable 700.

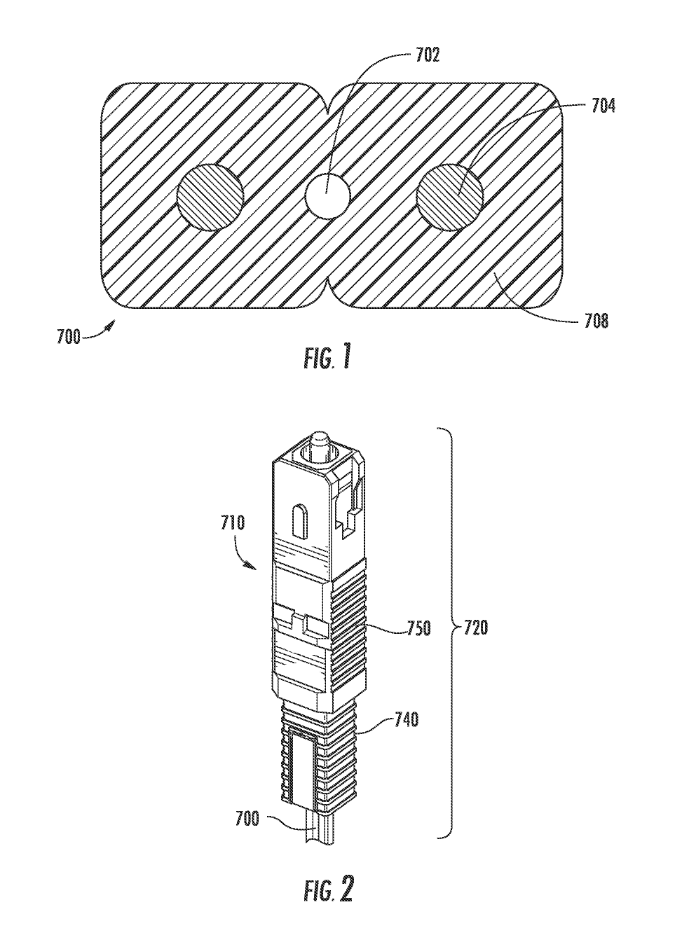

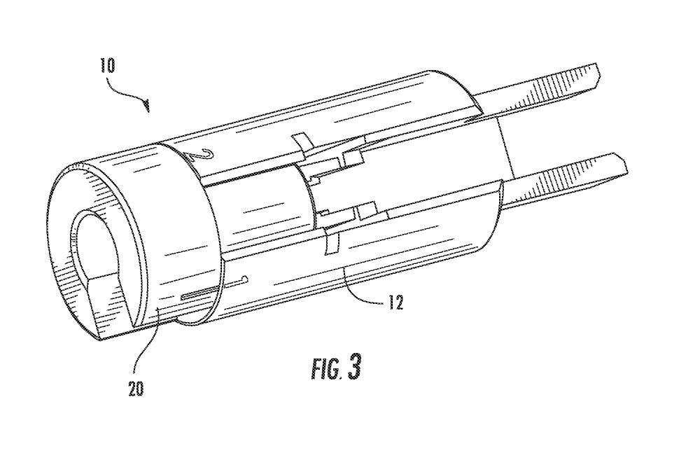

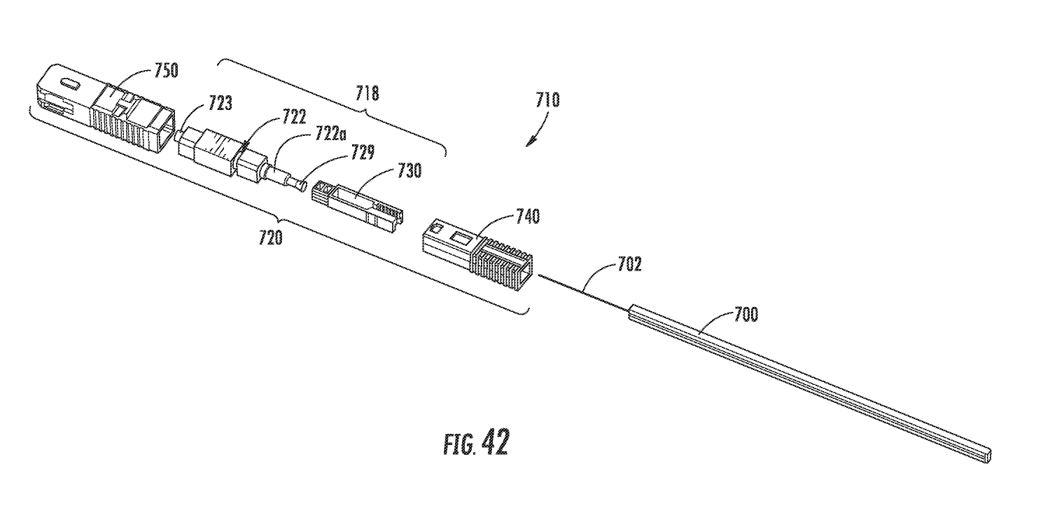

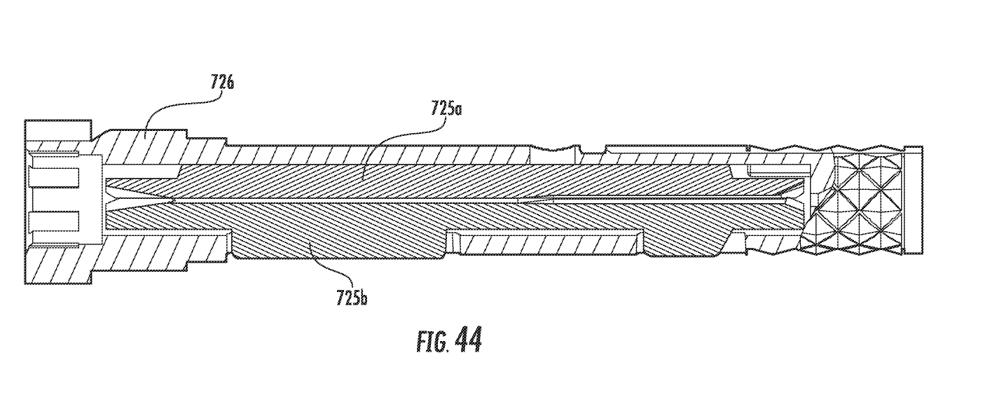

One fiber optic connector suitable to receive and terminate cable 700 is fiber optic connector 720, shown in FIG. 2 as part of a fiber optic cable assembly 710. Connector 720, available from Corning Cable Systems of Hickory, N.C., mechanically splices optical fiber 702 and a stub fiber (not visible) within connector 720. Connector 720 includes a sleeve 740 and cable 700, and assembly 710 is further defined by the addition of outer housing 750. As shown in FIGS. 42 and 45 and described herein in greater detail, sleeve 740 and outer housing 750 are positioned about a connector sub-assembly 718. Connector sub-assembly 718 includes a holder 730 having one end attached to a portion thereof and the other end adapted to grip cable 700. Sleeve 740 is adapted to cooperate with holder 730 after cable 700 is installed to maintain cable 700 within holder 730.

The termination tools disclosed are adapted to cooperate with connector sub-assembly 718, holder 730, sleeve 740 and cable 700 to terminate cable 700 and define cable assembly 710. However, assembly 710 is exemplary and other termination tool embodiments that cooperate in a like manner with other cables and other connector assemblies or sub-assemblies are within the scope of the disclosure.

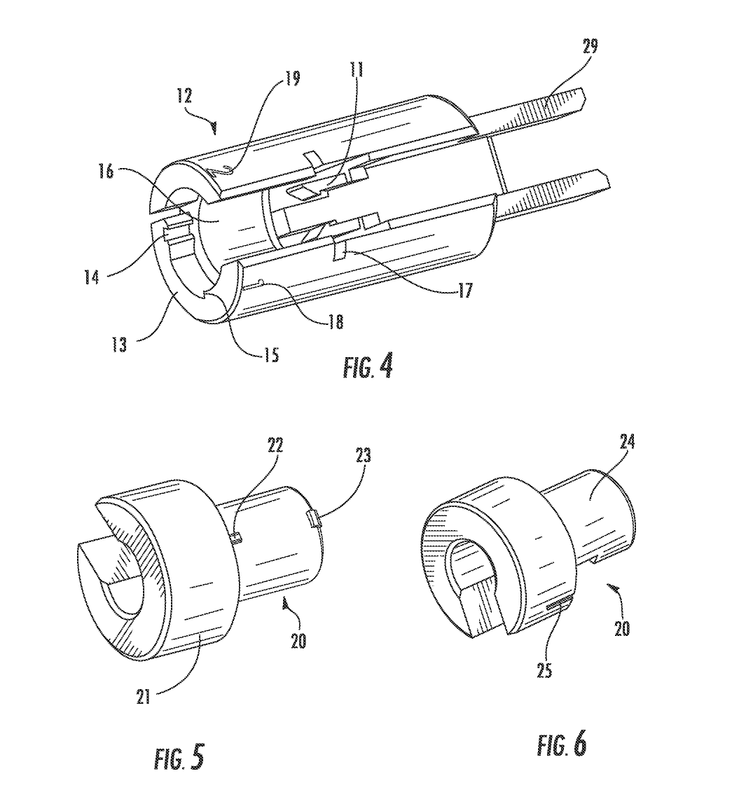

A first embodiment of the termination tools disclosed herein is illustrated in FIGS. 3-13. Specifically, FIG. 3 shows a perspective view of a termination tool 10. Tool 10 as shown is for hand held operation, but could be adapted to be, for example, a bench-top tool, an attachment for a motorized hand tool (e.g., a power drill) and a stand alone motorized hand tool. The tool 10 includes at least two parts formed from, for example, plastic. Specifically, termination tool 10 includes a base 12 and cam 20. Base 12 and cam 20 are assembled together to form termination tool 10. A connector is inserted into tool 10 in one end and a fiber optic cable is inserted into tool 10 from an opposite end. For instance, the connector is installed into a passageway of tool 10 from the front and is secured to tool 10 using, for example, at least one connector securing member in one embodiment in the form of at least one resilient catch 11 (FIG. 4). Catch 11 provides for axial insertion of the connector and lateral removal of the connector after termination. Axial, as used in the disclosure, means generally along a long axis of the tool 10. Lateral, as used in the disclosure, means a direction which is generally perpendicular to the long axis of tool 10. Generally, catch 11 allows axial insertion of the connector in one direction but provides an axial stop in the opposite direction as a resistance for inserting the cable into the connector for termination. The connecter securing member may be in the form of at least one catch 11 as described above or may be selected from, for example, at least one latch arm, hook, ball detent, pin or magnetic lock.

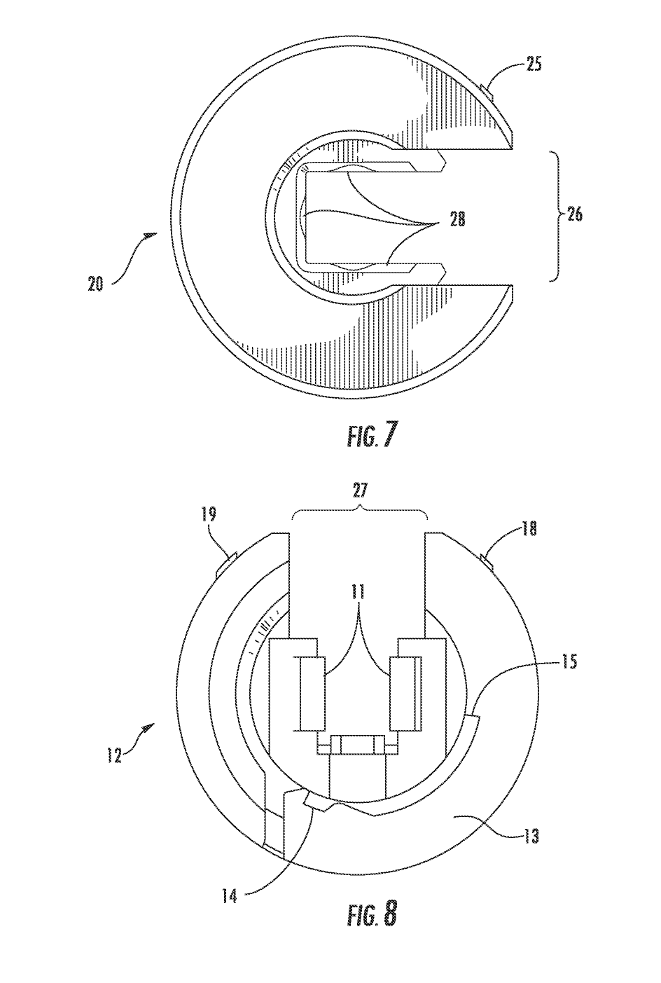

Referring now to the at least two parts of termination tool 10, FIG. 4 shows a perspective view of base 12 and FIGS. 5 and 6 show two perspective views of cam 20. Base 12 includes a cam receiving portion 16 in the interior of base 12 that operates to receive cam 20. Cam receiving portion 16 provides at least one surface that cooperates with at least one surface of a base insert portion 24 on cam 20. The surfaces of cam receiving portion 16 and base insert portion 24 in an exemplary embodiment are generally arcuate. Alternatively, cam receiving portion 16 and base insert portion 24 may also include one surface being generally arcuate and the other surface having generally planar surfaces, wherein cam 20 rotates relative to base 12 while making tangential contact. Upon assembly, cam 20 can be made to rotate in a direction within base 12, whereby base insert portion 24 slides across cam receiving portion 16. Conversely, base 12 can be made to rotate about cam 20, with cam receiving portion 16 sliding across base insert portion 24. In other words, cam 20 and base 12, while assembled together into termination tool 10, may rotate independently of each other.

As further shown in FIGS. 4 and 6, base 12 and cam 20 have positional indicators that may include visual (e.g., external markings), audible (e.g., a click), or tactile (e.g., a pulse or vibration) positional indicators. A first position marker 18 and a second position marker 19 are operable with a cam marker 25 to visually indicate a first position and a second position, in this embodiment respectively represented by numerals “1” and “2,” though other numbers, marks, letters, colors or the like are possible. During rotation, the first position is indicated when cam marker 25 is associated with first position indicator 18; and the second position is indicated when cam marker 25 is associated with second position marker 19. The first position corresponds to rib 22 being associated with detent 14, and the second position corresponds with rib 22 abutting stopper 15. In other embodiments tactile position indicators and visual position indicators may not necessarily correspond to the same relative positions. For example, due to changes in connector design more than two relevant rotational positions may be desired, with visual position indicators and tactile position indicators representing new and/or non-corresponding positions.

Base 12 further has a flexible arm 13 that has a free end and a fixed end. Flexible arm 13 defines a detent 14 near the free end and a stopper 15 near the fixed end. Detent 14 and stopper 15 are operable with rib 22 on cam 20 to provide a tactile positional indicator, indicating the relative rotational position of each part. During rotation, the free end of flexible arm 13 flexes radially when rib 22 encounters detent 14, allowing rib 22 to slip into and/or out of detent 14. Detent 14 is defined by a longitudinal groove or notch flanked by two ramp structures. The ramp structures permit rib 22 to force flexible arm 13 outward during rotation, allowing rib 22 to be associated with the groove or notch of detent 14. A tactile sensation and/or an audible “click” indicates that rib 22 is either associated with detent 14 or is outside of detent 14. Stopper 15 is located in an interior portion of base 12 and is operable to substantially stop a rotation of the cam 20 relative to base 12 by encountering rib 22. Stopped rotation indicates rib 22 has abutted stopper 15 and cam 20 has reached the end of a rotation cycle. A rotation cycle for cam 20 relative to base 12 is a rotational distance between rib 22 being associated with detent 20 and abutting stopper 15. Once rib 22 encounters stopper 15, cam 20 may be made to rotate in an opposite direction, for example, until rib 22 is once again associated with detent 14.

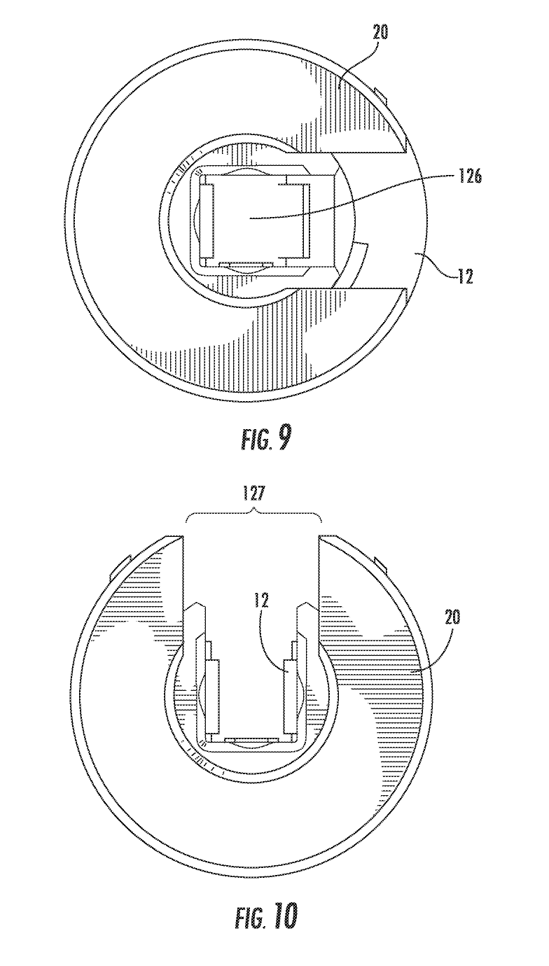

As shown in the end views of FIGS. 7 and 8, cam 20 and base 12 both have profiles with at least one open portion. For example, the profiles may be substantially arcuate (e.g., C-shaped or U-shaped) profiles having at least one open portion. The open portions in the profiles for cam 20 and base 12 define, respectively, a cam passageway 26 and base passageway 27, extending laterally from an area proximal to the middle of the parts through the periphery of the parts, and axially through the length of the parts FIG. 7 specifically shows an end view of cam 20. Mechanical splice activation surface 28, located within cam passageway 26, cooperates with a portion of a mechanical splice connector to activate a mechanical splice. Base passageway 27 defines catch 11. Cam passageway 26 and base passageway 27 cooperate to receive the connector and to release the connector, based upon their relative position to each other, as shown in FIGS. 9 and 10.

FIG. 9 shows an end view of the termination tool of FIG. 3. Cam 20 is axially mated with base 12 into a first position, which is a mechanical splice connector receiving position. Once the mechanical splice connector is received by tool 10 first position may be referred to as an unterminated position. A common axial passageway 126 extends through both cam 20 and base 12 and is operable to axially receive the connector or a connector sub-assembly 718 (FIG. 13) through cam 20. Cam passageway 26 and base passageway 27 are not aligned in FIG. 9, therefore there is no lateral opening through the entire termination tool. FIG. 10 shows an end view of the termination tool of FIG. 9 in the second position, where cam 20 is rotated from the first position by about 90 degrees, causing cam passageway 26 and base passageway 27 to rotationally align, forming common lateral passageway 127. Cam 20 and base 12 are axially mated and the termination tool 10 is assembled as shown in the following drawings and set out in the subsequent description.

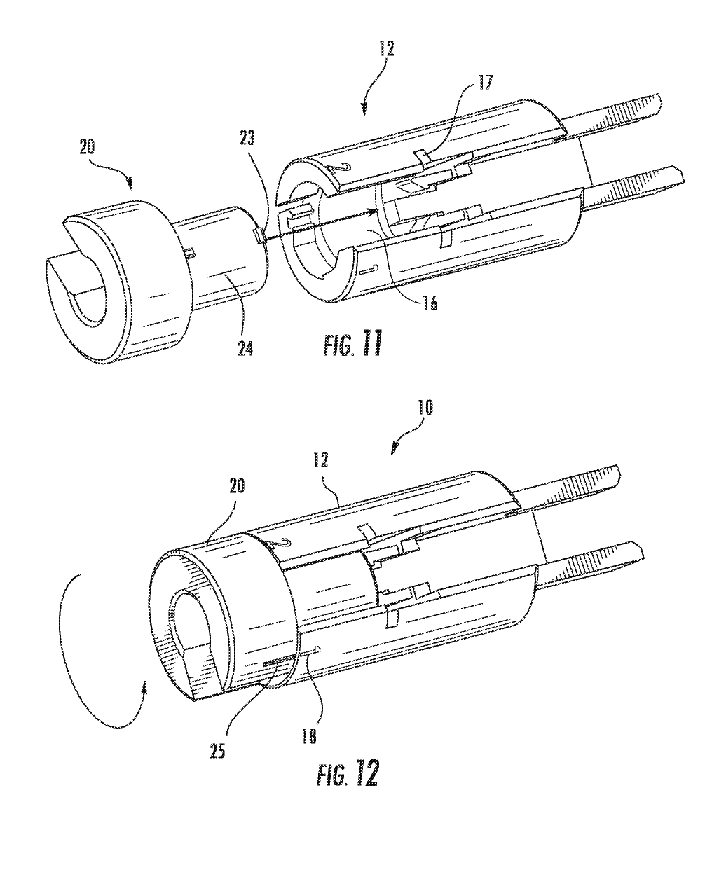

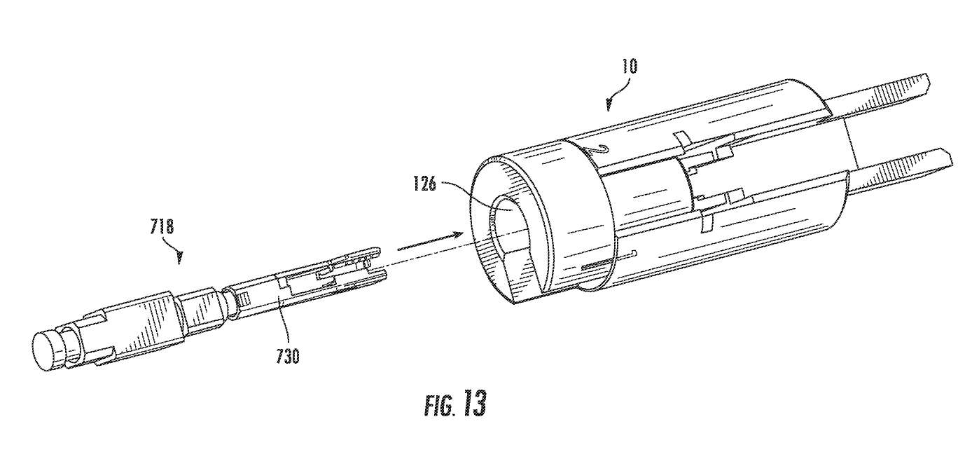

FIGS. 11 and 12 show perspective views of the termination tool 10 in different states of assembly using cam 20 and base 12. A cam securing member 23 is turned to be generally in line with passageway 27. Cam securing member 23 may be selected from a lip section, a hook or a finger on base insert portion 24 and is located on base insert portion 24. Cam 20 is axially inserted into base 12 until seated into cam receiving portion 16. Cam 20 is then rotated in a direction, in this embodiment counterclockwise, to engage securing member 23 with a receiving slot 17. Cam 20 is rotated until cam marker 25 is aligned with first position marker 18, which coincides with association of rib 22 with detent 14. The termination tool as shown in FIG. 12 is in the first position, ready to axially receive connector sub-assembly 718, as shown in a perspective view in FIG. 13.

In an exemplary embodiment, FIG. 13 shows a connector sub-assembly 718 entering the termination tool 10 through cam 20. Common axial passageway 126 has features that conform to the shape of the particular embodiment of connector sub-assembly 718. Other embodiments of a termination tool that receive other connectors or connector sub-assemblies will necessarily have other conforming features. Connector sub-assembly 718 has on one end a holder 730 that comprises the “rear” of the connector sub-assembly 718 and is the first part of connector sub-assembly 718 to enter termination tool 10. Holder 730, discussed below, has features that cooperate with the disclosed embodiments of termination tool 10 to terminate cable 700 to connector 720. Specific features of holder 730 are shown in greater detail in FIGS. 45 and 50.

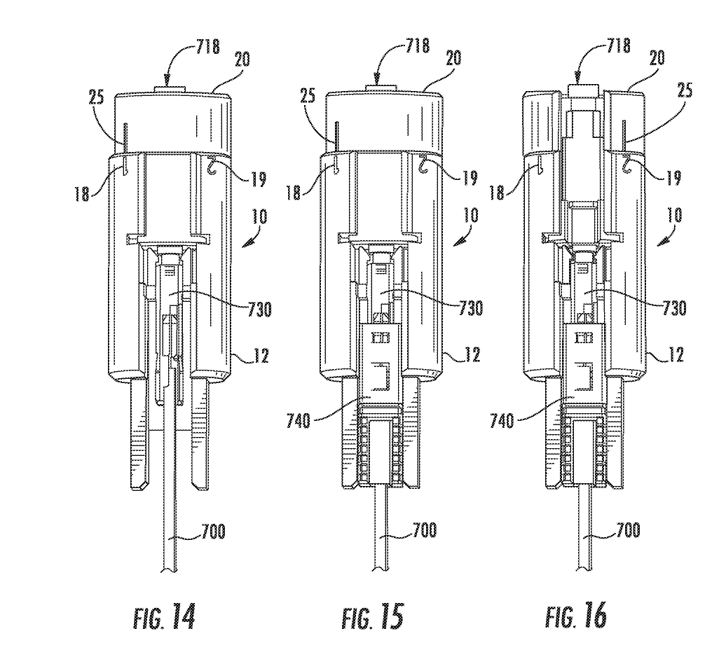

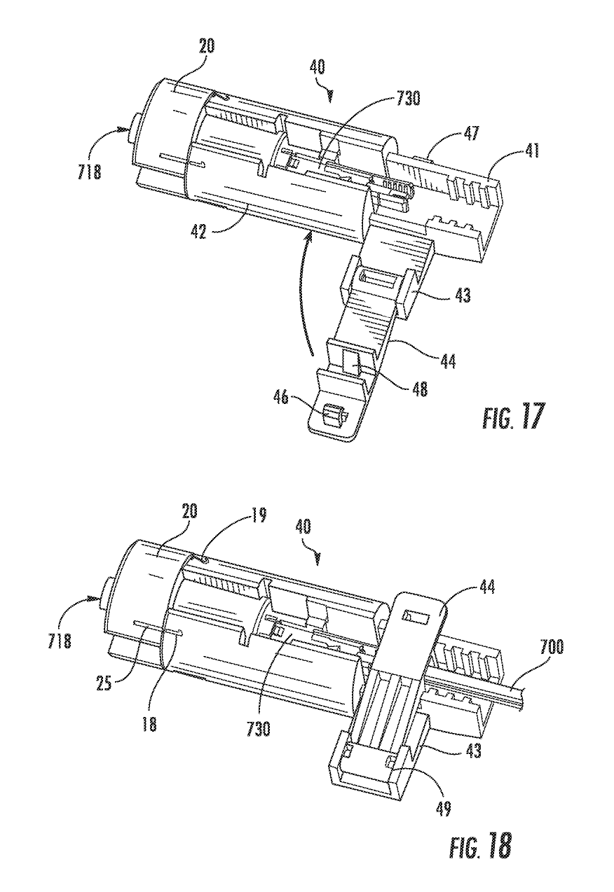

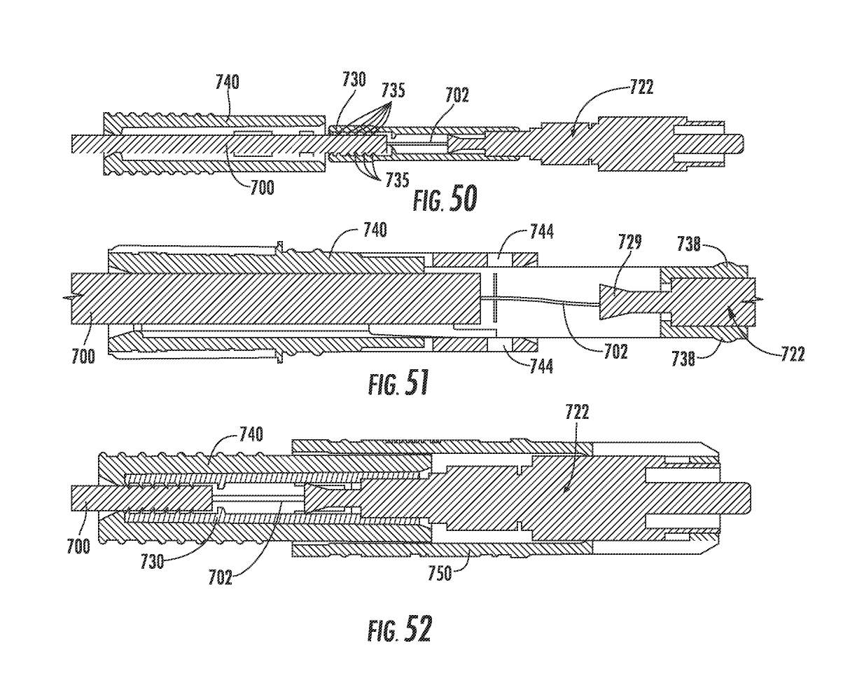

FIGS. 14-16 show a termination of cable 700 using termination tool 10. FIG. 14 shows a top view of the termination tool 10 having connector sub-assembly 718 therein with cable 700 disposed at the rear of holder 730. FIG.15 shows a top view of the tool 10 with a sleeve 740 disposed about cable 700 and a portion of holder 730. Sleeve 740 clamps a portion of the rear of connector sub-assembly 718 to cable 700 (FIG. 52). Catch 11 and sleeve 740 operate to hold connector sub-assembly 718 stationary relative to base 12 while cam 20 is turned from the first position to the second position using manual activation surface 21. This is indicated by realigning cam marker 25 from first position marker 18 to second position marker 19. Additionally, during this rotation rib 22 disassociates from detent 14 and abuts stopper 15. FIG. 15 shows the termination tool 10 in an unterminated position (first position). FIG. 16 shows a top view of the termination tool 10 in a terminated position (second position). By rotating cam 20 in an opposite direction the termination of the connector can be reversed, such as for remediation or cable replacement.

Other embodiments according to concepts disclosed herein are possible. FIGS. 17-20 show a termination tool 40 similar to termination tool 10 further including a clamping structure with a locking mechanism. FIG. 17 shows a perspective view of termination tool 40 having cam 20 and base 42. The clamping structure 48 provides additional structure to secure fiber optic cable 700 to holder 730 of connector sub-assembly 718 prior to termination. Clamping structure 48 is located at a distal end of a pivot arm 44. Pivot arm 44 is pivotally attached to a rigid side arm 43 that is rigidly attached to an alignment aid 41. Pivot arm 44 is pivotally attached to rigid side arm 43 by hinge 49, allowing a rotational or swiveling motion of at least about 45 degrees, and up to around 180 degrees. Hinge 49 may include pins cooperating with cavities, or may share a living hinge with rigid side arm 43. Clamping structure 48 has, for example, wedge ramps in a channel that force both sides of the end of holder 730 inward onto cable 700 (not visible). FIG. 18 shows a top perspective view of tool 40 with cable 700 disposed at the rear of the connector sub-assembly 718 having the pivot arm 44 in a locked position, further shown in FIG. 19.

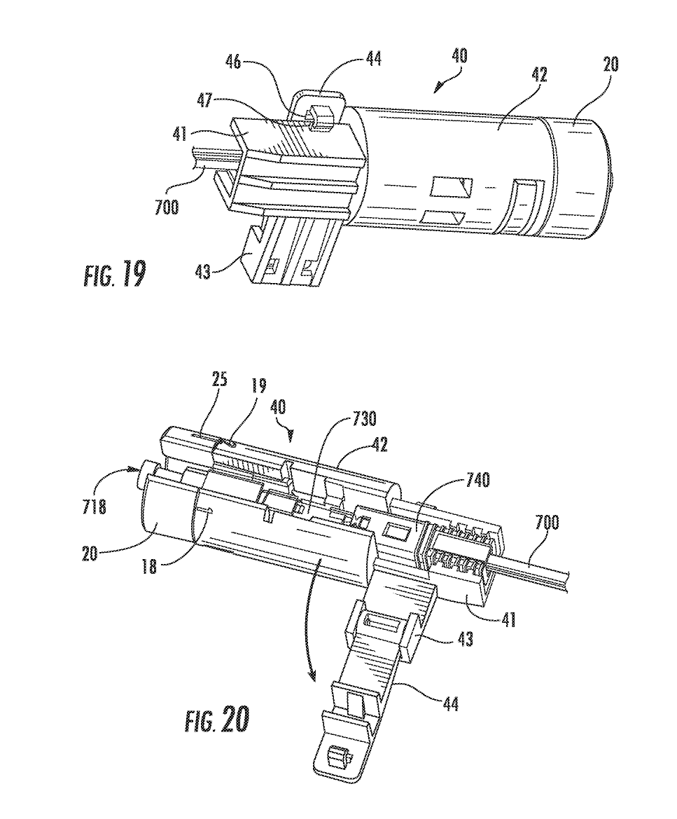

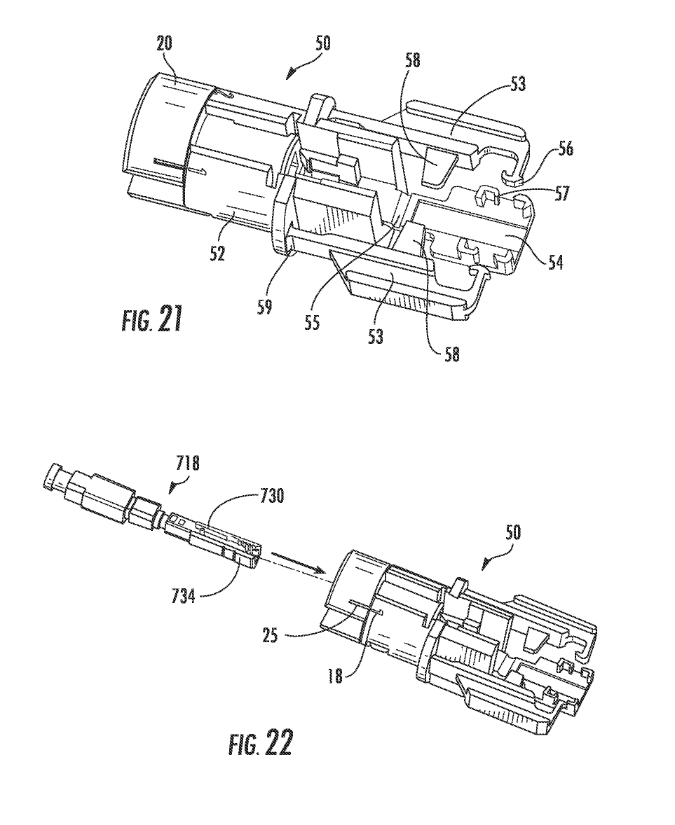

FIG. 19 shows a bottom perspective view of termination tool 40 wherein pivot arm lock 46 engages base lock 47 to secure cable 700 to connector sub-assembly 718, allowing freedom of handling to activate the mechanical splice with cam 20. Pivot arm lock 46 and base lock 47 can be configured to be snap locks. Thereafter, cam 20 may be rotated from the first position to the second position, thereby activating the mechanical splice. FIG. 20 shows a top perspective view of tool 40 in the terminated position with pivot arm 44 in an open position and sleeve 740 disposed about cable 700 and holder 730, displacing the clamping structure 48 and continuing to hold cable 700 to holder 730.

Another embodiment of a termination tool is shown in FIGS. 21-29. FIG. 21 shows a top perspective view of a termination tool 50 having side arms and a latch locking mechanism. Cam 20 is received in base 52, shown in the first position. Flexible side arms 53 are attached to base 52 at attachment point 59. Protrusion 58 extends from both flexible side arms 53 into the passageway 27, which provide a clamping structure for holder 730. The latch locking mechanism includes a vertical side arm latch 56 that cooperates with a vertical moveable release latch 57 to hold the flexible side arms 53 in a flexed position. Moveable release 54 is moveable downward, assisted by a groove 55, to allow the locking and unlocking of the latch locking mechanism. FIG. 22 shows a top perspective view of tool 50 prepared to receive connector sub-assembly 718 in a manner similar to that shown in FIG. 13. Connector sub-assembly 718 is shown entering common axial passageway 126 (see FIG. 9).

A method of terminating a mechanical splice connector to a fiber optic cable using tool 50 is set out below. The following description is given by way of example and is shown in FIGS. 23-30.

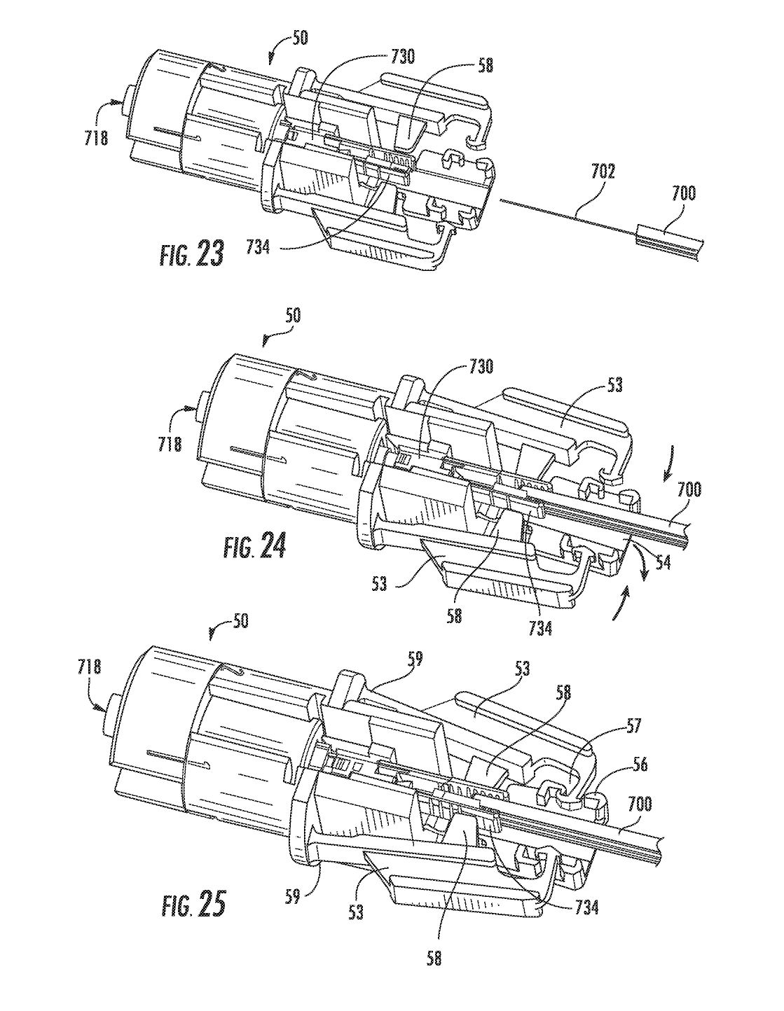

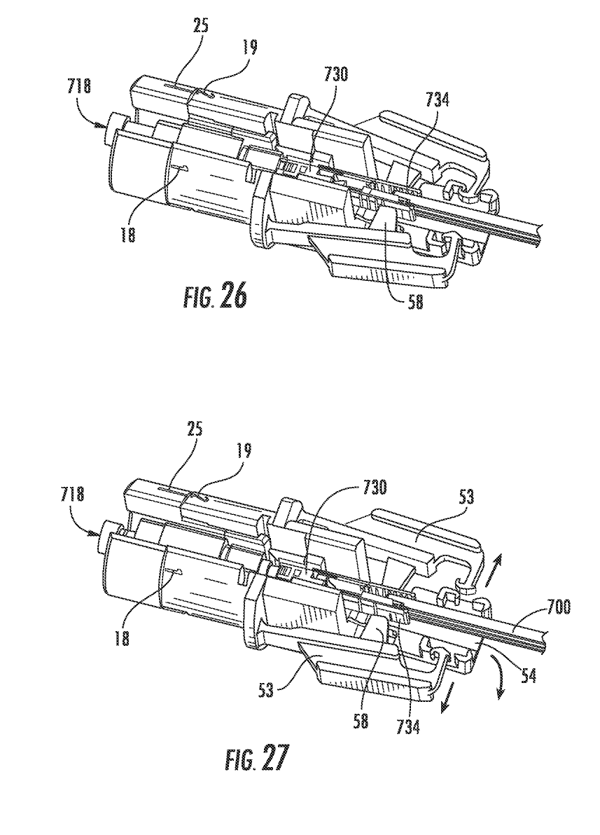

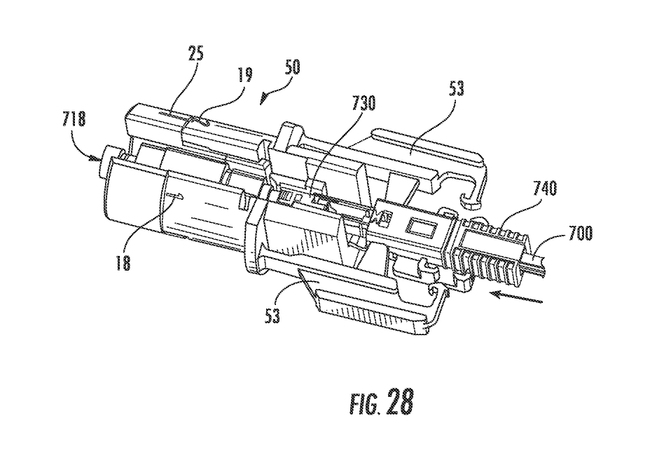

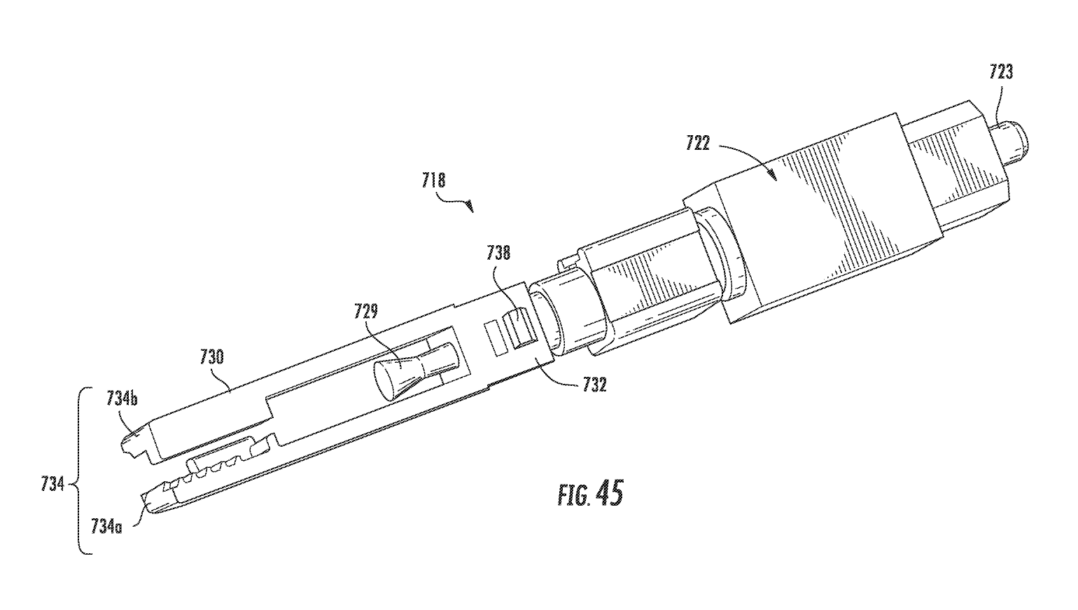

FIGS. 23-25 show a top perspective view of tool 50, having connector sub-assembly 718 disposed therein, receiving and securing a cable 700 into the end of holder 730. Optical fiber 702 is axially inserted into the connector sub-assembly 718 (shown in greater detail in FIGS. 47-52) until the jacket 708 is seated in between a pair of cantilevered arms 734 at the end of holder 730. Moveable release 54 is flexed downward (FIG. 24) to allow flexible side arms 53 to flex inward toward connector sub-assembly 718 to secure vertical side arm latch 56 to moveable side arm latch 57, thereby forcing protrusion 58 to press into each one of cantilevered arms 734 and securing fiber optic cable 700 (FIG. 25) therebetween. Tool 50 is shown in the unterminated position as indicated by the alignment of cam marker 25 and first position marker 18.

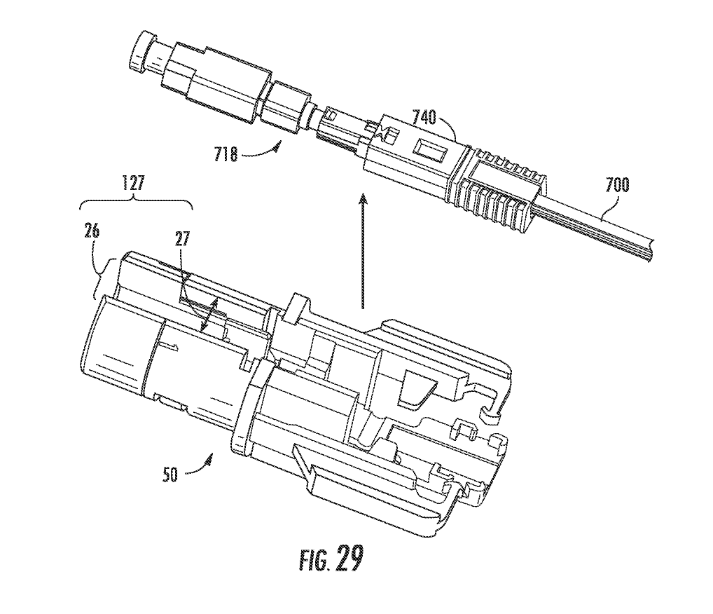

FIG. 26 shows a top perspective view of the embodiment of FIG. 25 in the terminated position, indicated by the alignment of cam marker 25 with second position marker 19, with the latch locking mechanism in a locked position. Moveable release 54 is flexed downward to release vertical side arm latch 56 from vertical moveable release latch 57, thereby freeing flexible side arms 53 to spring out and away from the connector sub-assembly 718 (FIG. 27). Tool 50 is now prepared to receive sleeve 740, as shown in FIG. 28 in a top perspective view. Sleeve 740, which is threaded onto cable 700, is moved axially along cable 700 until it reaches a stop disposed about cable 700 and cantilevered arms 734. At this point connector sub-assembly 718, terminated to cable 700 with sleeve 740 in position thereabout, is ready to be released from tool 50.

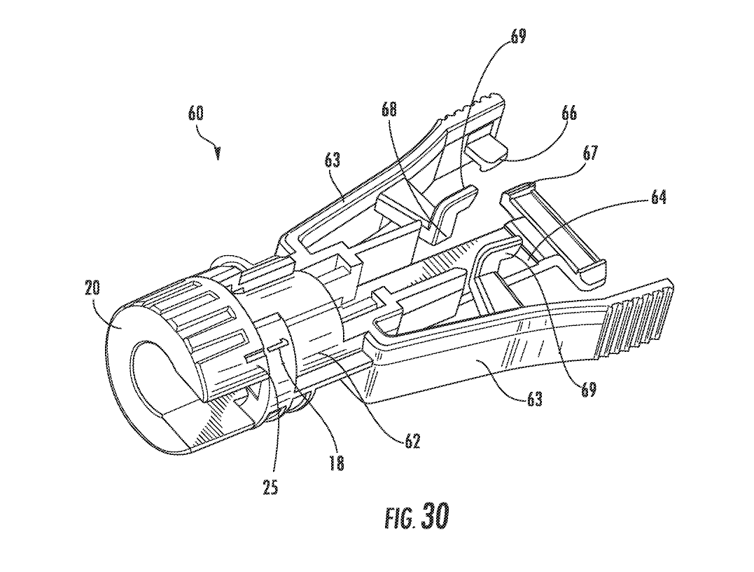

FIG. 29 shows a top perspective view of tool 50 laterally releasing the now terminated sub-assembly. The terminated sub-assembly is removed laterally via common lateral passageway 127 formed by aligning cam passageway 26 and base passageway 27. After connector sub-assembly is removed, sleeve 740 is pushed further along connector sub-assembly 718 to fully seat it to connector sub-assembly 718, defining connector 720. Connector assembly 710 is further defined by axially installing an outer housing 750 (see FIG. 42) about connector 720 opposite cable 700 (shown fully assembled in FIG. 2).

Another embodiment of a termination tool is shown in FIG. 30. Specifically, termination tool 60, similar to termination tool 50, has side arms and an alternate latch locking mechanism. Termination tool 60 includes cam 20 and base 62. Base 62 has flexible side arms 63 and moveable release 64. Flexible side arms 63 have protrusions 68, horizontal side arm latch 66 and prying assist 69. Sleeve 740 fits underneath or “hooks” prying assist 69, utilizing sleeve 740 to flex or pry moveable release 64 downward to unlatch the alternate latch locking mechanism. Moveable release 64 has horizontal moveable release latch 67 that cooperates with horizontal side arm latch 66 to secure and lock flexible side arms 63 in a flexed position. Mechanical splice connector assembly is performed as described in previous embodiments.

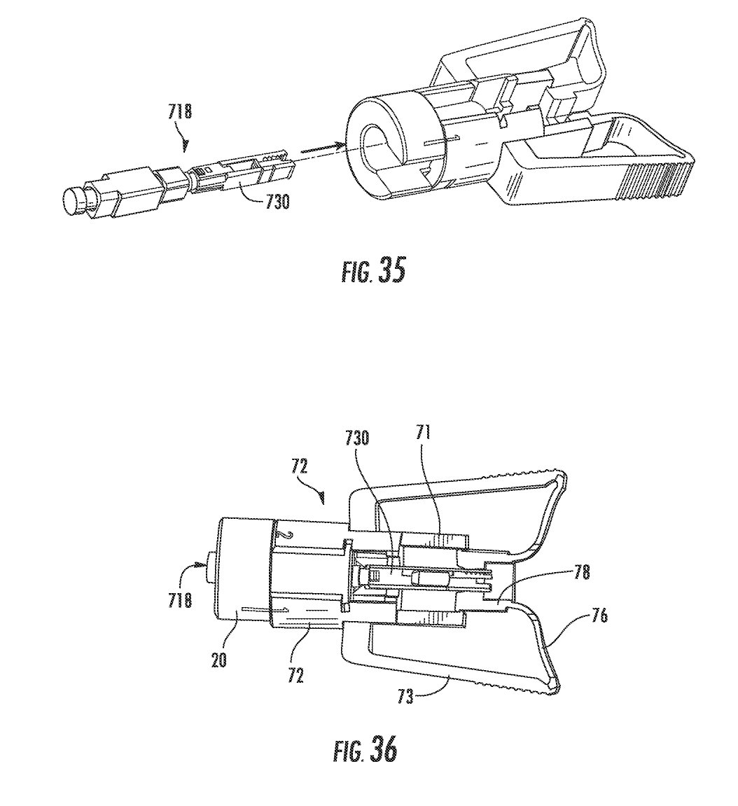

Another embodiment of a termination tool is shown in FIGS. 31-39. FIGS.

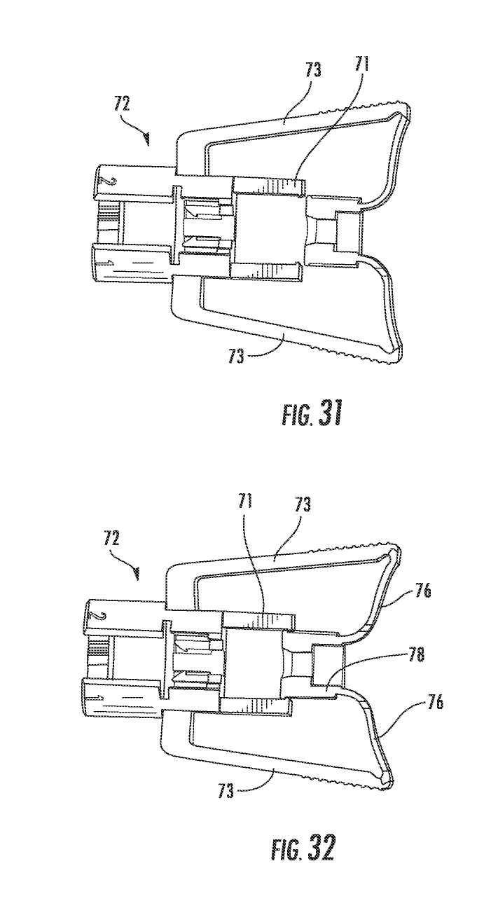

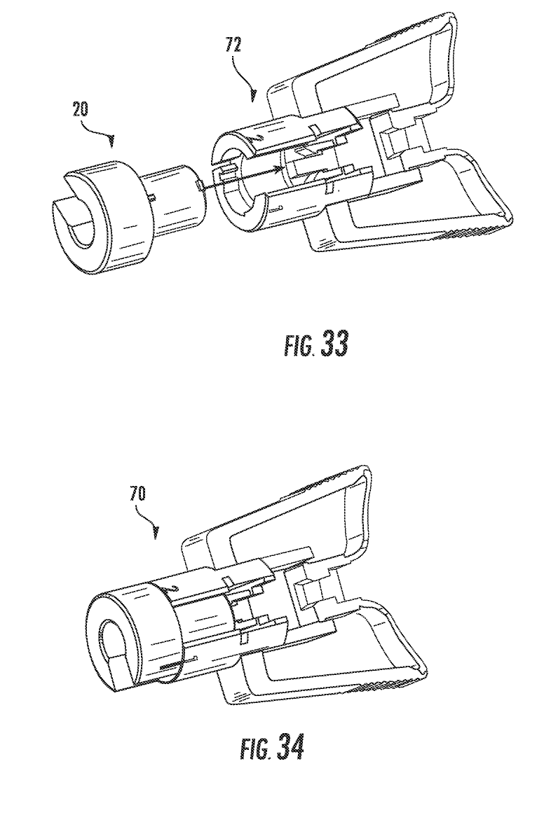

31 and 32 show two top views of a base 72 for a termination tool 70. Tool 70 is similar to termination tool 10, but includes a sliding clamping structure with a flexible bridge locking mechanism. Generally, a flexible bridge 76 is attached on one end to a flexible side arm 73 and on the other end to a sliding clamping structure 78. FIG. 31 shows base 72 prior to sliding clamping structure 78 engaging alignment aids 71. FIG. 32 shows base 72 after the sliding clamping structure 78 engages alignment aids 71. Alignment aids 71 allow axial translation of sliding clamping structure 78 within a predetermined axial path (not visible) while preventing lateral translation during lateral connector removal. Sliding clamping structure 78 is generally a channel having an opening oriented in a similar fashion as base lateral passageway 27. The opening has a narrow portion suitable for tightly sliding about cantilevered arms 734. The narrow portion is beveled to enable initial axial insertion of connector sub-assembly 718. The opening has a wide portion suitable to receive a portion of sleeve 740 during termination. When slide clamping structure 78 is in a forward position, cantilevered arms 734 may flex outward to allow insertion of the jacket 708 of cable 700 or another cable. Once cable jacket 708 is seated between cantilevered arms 734, sliding clamping structure 78 may move then to a rearward position, causing cantilevered arms 734 to clamp cable jacket 708, thereby securing cable 700 to connector sub-assembly 718.

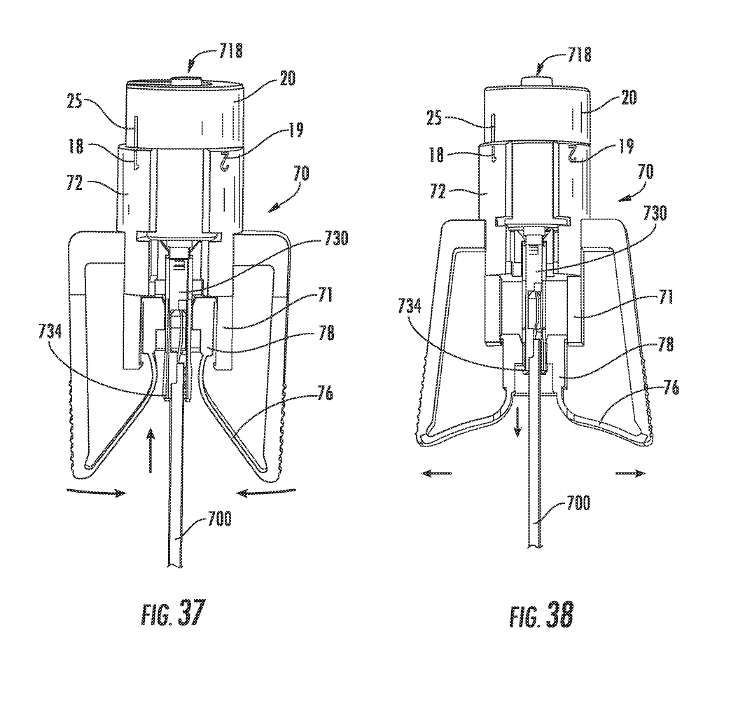

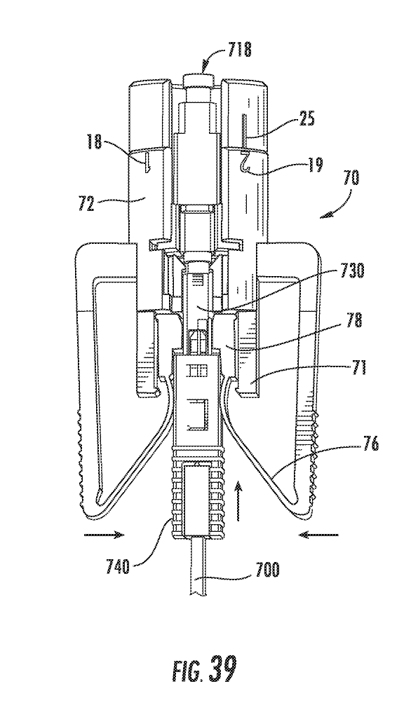

FIG. 33 shows a perspective view of the base 72 receiving cam 20 as in previous embodiments, thereby defining a termination tool 70. FIG. 35 shows a perspective view of tool 70 axially receiving a connector sub-assembly 718. FIG. 36 shows tool 70 in the unterminated position and connector sub-assembly 718 disposed therein, with sliding clamping structure 78 about the end of holder 730 in a rearward position. Insertion of cable 700 (FIG. 37) is enabled by squeezing flexible side arms 73, causing flexible bridge 76 to convert part of the lateral motion of the ends of side arms 73 into axial motion of the sliding clamping structure 78. Sliding clamping structure 78 will then translate axially to a forward position. FIG. 38 shows sliding clamping structure 78 in a rearward, locked position, held in place by the spring force of flexible side arms 73 and flexible bridges 76 as flexible side arms 73 are released and move outward.

FIG. 39 shows the tool 70 of FIG. 38 in the terminated position. Sliding clamping structure 78 is displaced by sleeve 740. Cam marker 25 is in alignment with second position marker 19, indicating that the mechanical splice has been activated. At this point the connector assembly 720 is ready for lateral removal as described in previous embodiments.

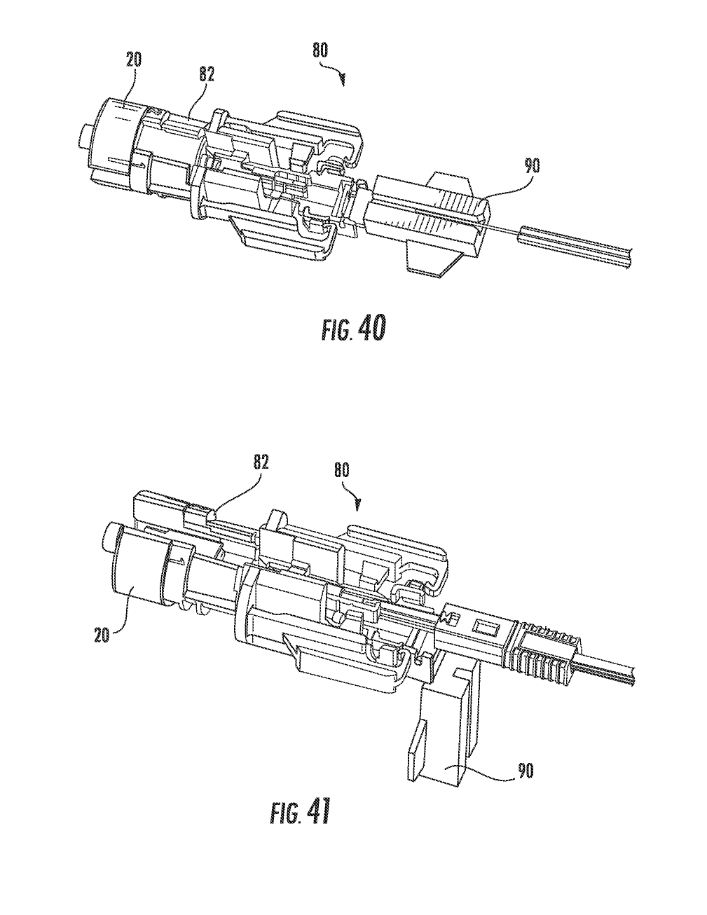

FIGS. 40 and 41 show a termination tool 80, similar to termination tool 50, including a pivoting cable guide 90. While pivoting cable guide 90 is shown on tool 80 very similar to termination tool 50, cable guide 90 may be installed on any termination tool embodiment disclosed. Termination tool 80 further includes cam 20, base 82. Pivoting cable guide 90 serves to assist alignment of, for example, cable 700, as it is inserted into the connector sub-assembly 718.

The preceding description of embodiments of a termination tool for terminating a fiber optic cable to a fiber optic connector is intended to be inclusive of any and all embodiments that are in keeping with the spirit of this disclosure. As an exemplary embodiment, the termination tools described herein are best used to terminate the fiber optic cable assemblies in the description that follows, though other fiber optic cable assemblies may be contemplated without departing from the spirit of the disclosure.

Referring back to FIG. 2 in more detail shows a perspective view of cable assembly 710 having connector 720 attached to cable 700. Cable assembly 710 can include any suitable fiber optic cable and/or type of connector according to the concepts disclosed herein. For instance, the connector type may include SC, LC, MT-RJ, MT, MU, or the like. Additionally, FIGS. 53-56 depict explanatory fiber optic cables suitable for use with the connectors disclosed herein. Fiber optic cables useful with the disclosed connectors generally are robust cable designs with strength members that have an anti-buckling characteristic such as glass-reinforce plastic, fiberglass, or the like, but the use of other suitable cables is possible. Connector 720 includes a suitable mechanical splice assembly such as similar to the connectors available under the trade names UniCam®, OptiSnap™, CamLite® from Corning Cable Systems of Hickory, N.C., but other suitable mechanical splice assemblies are possible. Moreover, the mechanical splice assemblies may be a single-fiber assembly or a multifiber assembly. The connectors disclosed herein quickly and reliably attach a robust drop cable to define a cable assembly, thereby providing a rugged solution that is field installable.

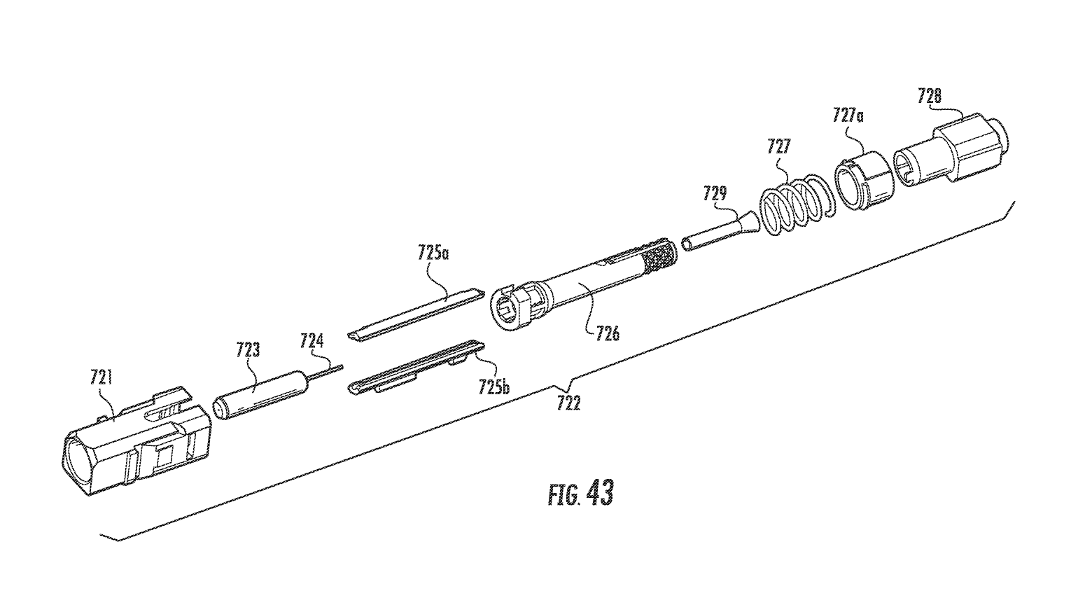

FIG. 42 is a partially exploded view of FIG. 2 showing connector 720 and fiber optic cable 700. Specifically, connector 720 includes mechanical splice assembly 722 having a ferrule 723, a holder 730, a sleeve 740, and an outer housing 750. As best shown in FIG. 43, ferrule 723 of mechanical splice assembly 722 has a stub optical fiber 724 attached thereto. The stub optical fiber 724 is attached to ferrule 723 and an endface of the ferrule (with the optical fiber stub) is finished in the factory, thereby eliminating these finishing steps in the field. Likewise, the free end of the stub optical fiber 724 is prepared to the desired length in the factory using any suitable method such as, for example, laser processing, and may have any suitable endface such as straight, angled, pencil-tip, etc. Consequently, the craft can prepare cable assembly 710 in the field by simply making a mechanical splice connection between stub optical fiber 724 and optical fiber 702 of fiber optic cable 700, thereby allowing a custom optical fiber connection between the optical fibers.

FIG. 43 depicts an exploded view of mechanical splice assembly 722. Mechanical splice assembly 722 includes a mechanical splice housing 721, a ferrule 723, stub optical fiber 724, splice parts 725a, 725b, a splice assembly housing 726, a spring 727 and spring retainer 727a, an activation mechanism 728, and a tube 729. However, other suitable mechanical splice assemblies can have fewer or more components. Likewise, the mechanical splice assemblies 722 may use any suitable activation mechanism 728. By way of example, a suitable activation mechanism 728 may be a cammed sleeve that biases the splice parts together using the rotation of an eccentric (e.g., rotational activation), thereby securing optical fiber 702 and stub optical fiber 724 in position for making the optical connection. FIG. 44 depicts a cross-sectional view of splice parts 725a, 725b disposed within splice assembly housing 726. As shown, the keel of splice part 725b extends through a window of splice assembly housing 726 so that the cammed sleeve can bias the splice parts together when rotated to the proper position as known in the art. In other embodiments, the activation mechanism of the mechanical splice connector may be a wedge that uses a linear activation in a generally parallel direction to the axis of the connector or a push button activation mechanism that use a linear activation in a transverse direction to the axis of the connector. Other suitable mechanisms for biasing one or more of the splice parts 725a, 725b together for securing optical fiber 702 and stub optical fiber 724 are also possible. Furthermore, the splice parts may be suitable for securing a portion of bare optical fiber, coated optical fiber, a portion of a buffered optical fiber, or combinations thereof by sizing one or more grooves on the splice parts accordingly.

Additionally, the activation mechanism may include a deactivation and/or reactivation feature for allowing the release of the splice parts if the mechanical splice does meet the desired performance level. In other words, the splice may be reversed by releasing the bias on the splice parts and repositioning and/or re-cleaving the optical fiber and then repositioning/re-inserting the optical fiber to make a suitable mechanical splice connection. By way of example, the cammed sleeve may be rotated in one direction to bias the splice parts together and rotation of the cam sleeve in the other direction releases the bias on the splice parts.

As known in the art, one or more of the components of the mechanical splice assembly may be translucent so the craft and/or a tool can view the glow of the mechanical splice for evaluating the continuity of the mechanical splice as known. For instance, U.S. Pat. No. 6,816,661 discloses methods for evaluating the continuity of the mechanical splice. In the embodiment depicted, mechanical splice assembly 722 uses a cammed sleeve as the activation mechanism 728. Moreover, the cammed sleeve and the splice parts are translucent so the craft and/or tool may view the glow of the mechanical splice to evaluate the continuity of the mechanical splice.

FIG. 45 shows a perspective view of a portion or sub-assembly 718 of connector 720 before attaching fiber optic cable 700 thereto. Holder 730 has a first end 732 for attaching to a portion of fiber optic connector 720 and a second end 734 for securing to a portion of cable 700 such as by clamping to the cable jacket 708 of cable 700. As shown, the components of mechanical splice assembly 722 are assembled and holder 730 is placed about a portion of the connector 720 such as a rear portion of the connector. Specifically, first end 732 of holder 730 has a passageway sized to fit over a collar 722a disposed at the rear end of mechanical splice assembly 722. In this embodiment, holder 730 is attached to sleeve 722a using a suitable adhesive like, for example, glue or epoxy. Other methods for attaching holder 730 to a portion of the connector 720 are possible such as a snap-fit, interference fit, crimping, threads or the like so long as the attachment has the desired strain relief (e.g., retention force) between the holder 730 and mechanical splice assembly 722 for the cable assembly. In this embodiment, holder 730 is placed about the rear portion of mechanical splice assembly 722 so that tube 729 extends into an interior space of holder 730 as shown. In exemplary embodiments, holder 730 is attached to mechanical splice assembly 722 in the factory for providing a craft-friendly field solution. In other words, the connector bag of parts from the factory is ready to receive a properly prepared fiber optic cable with just a few parts requiring assembly in the field. Holder 730 and sleeve 740 may also be provided individually for use with a standard mechanical splice connector since tube 729 of mechanical splice assembly 722 may also function as a crimp tube for attaching fibrous strength elements (e.g., aramid fibers).

The second end 734 of holder 730 is configured for securing a portion of cable 700 thereto. The second end 734 of holder 730 is sized for any suitable shaped and/or sized fiber optic cable. Thus, the disclosed holder design be modified to work with many different types/sizes of fiber optic cables such as available from different cable manufacturers. In this embodiment, second end 734 of holder 730 includes a first cantilevered arm 734a and a second cantilevered arm 734b that extend rearward for securing to a portion of fiber optic cable 700 therebetween. Specifically, first cantilevered arm 734a and second cantilevered arm 734b can deflect towards each other for clamping to a portion of fiber optic cable 700. As shown in FIG. 45, first cantilevered arm 734a and second cantilevered arm 734b may include one or more stops for aiding in the proper placement of fiber optic cable 700 between the cantilevered arms. In other words, the stops aid in the proper placement of the fiber optic cable in one or more directions such as fully seated in a longitudinal direction of the connector and/or the vertical direction within the holder 730. The sizing of the stops may be dependent on the specific cable design/size intended for the cable assembly, but the size and/or shape of the stops may be adjusted accordingly to the fiber optic cable. In other embodiments, the holder may have a single cantilevered arm or use other structure to secure the fiber optic cable.

As shown in FIG. 50, cantilevered arms 734a, 734b may also include one or more gripping teeth 735 for “biting” into cable jacket 708 of cable 700. Gripping teeth 735 are designed to bite into cable jacket 708 as the sleeve 740 is slid onto holder 730 during assembly, thereby squeezing cantilevered arms 734a, 734b onto cable jacket 708. As shown, both cantilevered arms 734a, 734b include a plurality of gripping teeth 735 for biting into the jacket 708 of fiber optic cable 700; however, other embodiments may not use gripping teeth or use gripping teeth on only one cantilevered arm. Additionally, specific shaping of teeth 735 such as canted forward (e.g., asymmetrical) may inhibit movement and/or apply a forward force to the cable 700 when the cantilevered arms are squeezed into the cable jacket 708, thereby improving gripping of the cable and strain relief (i.e., the fiber optic cable retention). By way of example, teeth 735 have a height between about 0.002 inches (0.05 millimeters) and about 0.010 inches (0.254 millimeters) for “biting” into cable jacket, preferably, between about 0.004 inches (0.10 millimeters) and about 0.008 inches (0.20 millimeters) depending on materials characteristics and/or the shape of the teeth 735. Thus, connector sub-assembly 718 provides a fiber optic cable retention force (i.e., a cable pull-out force) of at least 10 Newtons, more preferably about at least 20 Newtons.

Holder 730 and sleeve 740 may also have cooperating structure for inhibiting unintended disassembly therebetween. Specifically, holder 730 also includes one or more protrusions 738 for latching with one or more portions of sleeve 740, thereby inhibiting separation of the sleeve 740 from the holder 730 after assembly. Holder 730 and sleeve 740 may also have cooperating structure to inhibit over-insertion of sleeve 740 onto holder 730. Illustratively, sleeve 740 includes one or more stops 745 for abutting to a surface 735 located on holder 730. Stops 745 project slightly inward toward the passageway of sleeve 740 so that they abut surface 735 as shown in FIG. 52. Sleeve 740 includes two stops 745 disposed on opposite sides. Further, it is possible to form holder 730 from any suitable material(s). By way of example, holder 730 is formed from a suitable polymer such as available under the trade name ULTEM® available from GE Plastics; however, other suitable polymers and/or composite of materials are possible.

Cable 700 is suitably prepared for assembly by exposing, stripping and cleaving the optical fiber to the proper lengths for attaching to connector 720. In one embodiment, sleeve 740 can have one or more gauges or indicators for aiding the craft in preparing the fiber optic cable for termination with connector 720. Illustratively, FIG. 46 is a perspective view showing cable 700 positioned on sleeve 740. As shown, sleeve 740 has a relieved portion (see FIG. 48 for unobstructed view) for positioning a prepared portion of cable 700 therein. Relative to relieved portion, a stripping gauge 742 is positioned on the other end of sleeve 740. In this embodiment, stripping gauge 742 includes a plurality of arrows to indicate a minimum length of coating (e.g., 250 micron coating) that should remain on optical fiber 702 from an endface of the cable jacket 708 that is placed in the relieved portion of sleeve 740. Thus, it is not required to mark and measure the correct distance for the stripped portion of optical fiber 702. Additionally, the sleeve 740 may have a marking indicating what size fiber optic cable that the connector 720 is suitable for terminating. By way of example, sleeve 740 includes the marking “2.0×3.1” indicating that connector 720 is suitable for that size fiber optic cable as shown.

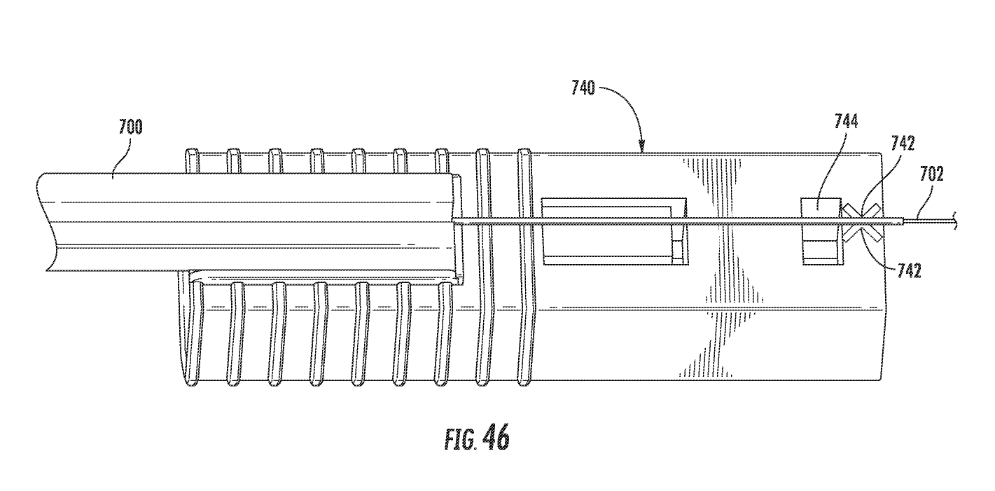

After cable 700 is properly prepared by exposing, stripping and cleaving optical fiber it is ready for inserting into the holder 730 attached to mechanical splice assembly 722. First, sleeve 740 is threaded onto fiber optic cable 700 in the proper orientation for sliding forward onto holder 730 once the fiber optic cable 700 and optical fiber 702 are properly placed within the intended portions of connector 720. FIG. 47 is an assembly view showing the prepared cable 700 inserted into a portion of connector 720 before the sleeve 740 is slid into place. As shown, cable 700 is positioned so that optical fiber 702 is inserted into tube 729, thereby guiding optical fiber 702 in between the splice parts 725a, 725b of the mechanical splice assembly 722. Also, cable 700 is properly positioned so that it generally abuts the appropriate stops of holder 730. Thereafter, sleeve 740 is slid onto a portion of holder 730 as represented by the arrow in FIG. 48 and FIG. 49, thereby squeezing the teeth 735 and/or cantilevered arms 734a, 734b into cable jacket 708.

As shown in FIG. 49, sliding sleeve 740 about a portion of holder 730 may cause optical fiber cable 700 to slide forward slightly and create a bend B in optical fiber 702. Creating a bend in optical fiber 702 provides an abutting force and assures mechanical contact between the optical fibers in the mechanical splice. Sliding forward of sleeve 740 continues until it is fully seated on holder 730 and over-insertion is inhibited by stops 745. In this embodiment, sleeve 740 includes windows 744 disposed on opposite sides for cooperating with respective protrusions 738 on holder 730 for inhibiting unintended movement between the components. Stated another way, sleeve 740 is slid forward about holder 730 until protrusions 738 are held in windows 744 of sleeve 740. Sleeve 740 includes a suitably sized longitudinal passageway for fitting over holder 730 and squeezing the cantilevered arms 734 onto the cable jacket with the desired force.

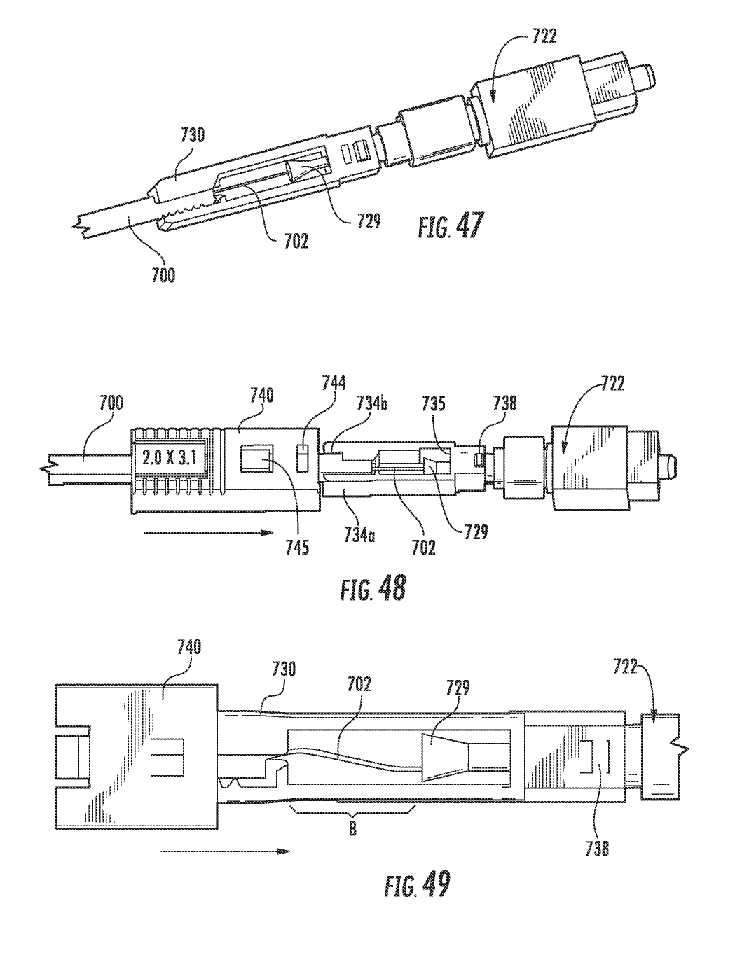

FIGS. 50 and 51 depict cross-sectional views of the sleeve 740 being slid into position during assembly in orthogonal directions and FIG. 52 shows a cross-sectional view of cable assembly 710 along the same plane as FIG. 50. It is noted that the cross-sectional details of mechanical splice assembly 722 are omitted from FIGS. 50-52 for the purposes of simplicity. In exemplary embodiments, the longitudinal passageway of sleeve 740 has a tapered passageway or a passageway that has a reduced dimension along a portion of its length (FIG. 50) in the direction for squeezing the teeth 735 and/or cantilevered arms 734a, 734b of holder 730 into cable jacket 708. In other words, the forward opening of the passageway has opening sized for accommodating the fiber optic cable 700 that is loosely disposed in holder 730. As the holder 730 moves into the passageway of sleeve 740 the opening decreases in size in the desired direction, thereby forcing the cantilever arms 734a, 734b together to grip the cable jacket 708 of fiber optic cable 700. By way of example, the passageway of sleeve 740 may reduce its size by about 0.004 inches (0.10 millimeters) to about 0.020 inches (0.50 millimeters) in the desired direction, but other suitable dimensions are possible. After the sleeve 740 is installed, the outer housing 750 can be attached to connector 720, thereby completing cable assembly 710. Specifically, outer housing 750 is slid over the front of mechanical splice assembly 722 of connector 720 and is secured to mechanical splice housing 721.

Termination tool assemblies and connectors disclosed herein may use any suitable fiber optic cable. For example, fiber optic cables can have different shapes and/or construction while being suitable with the connectors disclosed herein. For instance, the fiber optic cable can have cross-sectional shapes such as oval, flat, round, square, dogbone, or the like. Cable 700 in FIG. 1 has been discussed by way of example. Alternatively, FIGS. 53-56 depict cross-sectional views of further explanatory fiber optic cables for use with termination tool assemblies and connectors disclosed herein. FIG. 53 shows fiber optic cable 810 that has a larger cross-sectional profile with a dogbone shape for use with the disclosed connectors. The dogbone shape of cable 810 allows the cable to withstand relatively large crush forces without experiencing undesirable levels of optical attenuation.

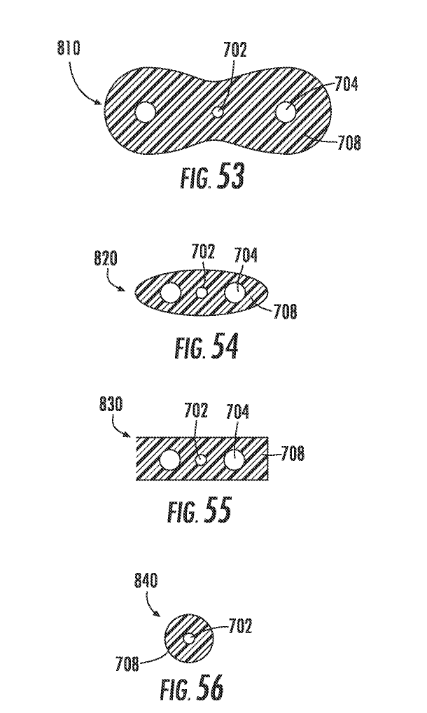

FIGS. 54-56 respectively show still other variations of fiber optic cables suitable for use with the disclosed termination tools and connectors. FIGS. 54 and 55 respectively depict fiber optic cables 820 and 830 showing that other cable shapes are possible with the connectors and cable assemblies disclosed. FIG. 56 depicts a buffered optical fiber 840 having a round profile. Simply stated, the cables need not include a strength member. Other variations to the holder are also possible when different cable types and/or shapes are used. For instance, the holder may have a generally round profile for use with a round cable as shown in FIG. 56. Further, this round holder may include more than two cantilevered arms and use a sleeve with a tapered cylindrical passageway for squeezing the cantilevered arms into the cable jacket. But the round cable can also use holders as illustrated herein. Although FIGS. 1 and 53-56 depict single fiber cables the concepts disclosed may also be used with multifiber cables and a suitable connector. By way of example, any of the fiber optic cables disclosed may have multiple optical fibers and the mechanical splice assembly would be suited for making an optical splice between multiple stub optical fibers and optical fibers of the cable.

The foregoing is a description of various embodiments of the disclosure that are given here by way of example only. Although a termination tool for terminating a fiber optic cable to a mechanical splice connector according to the disclosure has been described with reference to preferred embodiments and examples thereof, other embodiments and examples may perform similar functions and/or achieve similar results. All such equivalent embodiments and examples are within the spirit and scope of the present disclosure and are intended to be covered by the appended claims.

What is claimed is:

1. A termination tool for terminating a fiber optic cable to a mechanical splice connector, comprising:
a base, said base having a cam receiving portion and a clamping structure;
a cam, said cam axially received in the cam receiving portion and adapted to rotate within the cam receiving portion from a first position to a second position; and
at least one of the base and cam receives a mechanical splice connector.

2. The termination tool of claim 1, wherein at least a portion of the cam and the base each have a lateral passageway therethrough extending from at least a medial portion of the cam and base through a lateral portion of the cam and base.

3. The termination tool of claim 1, wherein the one of the cam and the base is adapted to laterally release the mechanical splice connector.

4. The termination tool of claim 1, the base further including a connector securing member for securing the mechanical splice connector.

5. The termination tool of claim 1, wherein the cam and base define a common axial passageway in the first position and a common lateral passageway in the second position.

6. The termination tool of claim 5, wherein the first position is a mechanical splice connector receiving position and the mechanical splice connector is axially received through the common axial passageway.

7. The termination tool of claim 5, wherein the second position is a mechanical splice connector release position and the mechanical splice connector is laterally released through the common lateral passageway.

8. The termination tool of claim 5, the cam further including a cam securing member for securing the cam to the base.

9. The termination tool of claim 5, the base further including a slot for securing the base to the cam.

10. The termination tool of claim 5, wherein the first position is an unterminated position and the second position is a terminated position.

11. The termination tool of claim 1, the base and the cam including at least one positional indicator.

12. The termination tool of claim 11, wherein the at least one positional indicator comprises a detent.

13. The termination tool of claim 11, wherein the at least one positional indicator is an over-rotation stopper.

14. The termination tool of claim 11, wherein the at least one positional indicator is indicia.

15. The termination tool of claim 1, including a pivoting fiber optic cable guide.

16. The termination tool of claim 1, wherein the termination tool is a hand held termination tool.

17. The termination tool of claim 1, wherein the clamping structure is selected from at least one wedge ramp, at least one protrusion, and at least one sliding clamping structure.

18. The termination tool of claim 17, wherein the at least one wedge ramp is attached to at least one pivoting side arm.

19. The termination tool of claim 17, wherein the at least one protrusion is attached to at least one flexible side arm.

20. The termination tool of claim 17, wherein the sliding clamping structure is in communication with at least one flexible side arm by at least one flexible bridge.

21. The termination tool of claim 17, wherein the base includes a locking mechanism for securing the clamping structure to the base.

22. A method of assembling a termination tool, comprising:
providing a cam having a base insert portion and at least one cam securing member;
providing a base having a cam receiving portion, a passageway and a slot;
axially aligning the base insert portion to the cam receiving portion;
rotating the cam to align the securing member to the passageway on the base;
axially inserting the base insert portion into the cam receiving portion; and
rotationally engaging the securing member and the slot.

23. The method of claim 22, including rotationally aligning a rib on the cam to a detent on the base.

24. The method of claim 22, the cam securing member including at least one hook.

25. A method of terminating an optical fiber to a mechanical splice connector, comprising:
providing a termination tool having a base and a cam;
providing a mechanical splice connector;
axially inserting the mechanical splice connector into the termination tool assembly, wherein the cam is in a first position;
providing a fiber optic cable;
inserting the fiber optic cable into the mechanical splice connector;
rotating the cam to a second position; and
laterally removing the mechanical splice connector and fiber optic cable.

26. The method of claim 25, further including the step of actuating a clamping structure on the termination tool to secure the fiber optic cable to the mechanical splice connector.
